(19) United States
(12) Patent Application Publication
(10) Pub. No.: US 2012/0077546 A1
(43) Pub. Date: Mar. 29, 2012

(54) METHOD AND APPARATUS FOR CUSTOMIZING APPLICATION PROTOCOLS

(75) Inventors: Claude Kawa, Montreal (CA); Jonathan Skypek, Alpharetta, GA (US); Patrick Arsenault, Montreal (CA)

(73) Assignee: Nokia Corporation, Espoo (FI)

(21) Appl. No.: 12/890,145

(22) Filed: Sep. 24, 2010

(51) Int. Cl. H04W 88/02; G06F 9/44

(52) U.S. Cl. 455/566; 717/168

(57) ABSTRACT

An approach is provided for customizing application protocols. A protocol management module receives a request to execute an application at a device. The application includes a set of protocol features. The protocol management module determines one or more protocols for the application based, at least in part, on one or more criteria. The protocol management module then determines a subset of the protocol features to enable or disable based, at least in part, on the one or more protocols.

### BACKGROUND

Service providers and device manufacturers (e.g., wireless, cellular, etc.) are continually challenged to deliver value and convenience to consumers by, for example, providing compelling network services. One aspect of providing such services (e.g., instant messaging, electronic mail, social networking, etc.) includes facilitating the development of client applications for use across a broad range of networks, devices, and the like over which the services operate. By way of example, network operators often request versions of client applications that are customized specifically for a particular network. In many cases, the customizations relate to protocols (e.g., communication protocols such for instant messaging, chat sessions, etc.) that are uniquely specified and/or selected by the respective network operators or other service providers, while the underlying application code remains substantially the same across different versions of the client application. As a result, the service providers and device manufactures face significant technical challenges to enabling efficient customization (e.g., dynamic customization) of protocols that are used by client applications.

### Some Example Embodiments

Therefore, there is a need for an approach to control the customization process, including the protocol(s) utilized, so that to the extent possible, common application code can be used to support protocols that are specific to individual operators, services, etc.

According to one embodiment, a method comprises receiving a request to execute an application at a device. The application includes a set of protocol features. The method also comprises determining one or more protocols for the application based, at least in part, on one or more criteria. The method further comprises determining a subset of the protocol features to enable or disable based, at least in part, on the one or more protocols.

According to another embodiment, an apparatus comprises at least one processor, and at least one memory including computer program code for one or more programs, the at least one memory and the computer program code configured to, with the at least one processor, cause, at least in part, the apparatus to receive a request to execute an application at a device. The application includes a set of protocol features. The apparatus is also caused to determine one or more protocols for the application based, at least in part, on one or more criteria. The apparatus is further caused to determine a subset of the protocol features to enable or disable based, at least in part, on the one or more protocols.

According to another embodiment, a computer-readable storage medium carries one or more sequences of one or more instructions which, when executed by one or more processors, cause, at least in part, an apparatus to receive a request to execute an application at a device. The application includes a set of protocol features. The apparatus is also caused to determine one or more protocols for the application based, at least in part, on one or more criteria. The apparatus is further caused to determine a subset of the protocol features to enable or disable based, at least in part, on the one or more protocols.

According to another embodiment, an apparatus comprises means for receiving a request to execute an application at a device. The application includes a set of protocol features. The apparatus also comprises means for determining one or more protocols for the application based, at least in part, on one or more criteria. The apparatus further comprises means for determining a subset of the protocol features to enable or disable based, at least in part, on the one or more protocols.

According to another embodiment, a method comprises facilitating access to at least one interface configured to allow access to at least one service, the at least one service configured to receive a request to execute an application at a device. The application includes a set of protocol features. The at least one service is also caused to determine one or more protocols for the application based, at least in part, on one or more criteria. The at least one service is further caused to determine a subset of the protocol features to enable or disable based, at least in part, on the one or more protocols.

According to another embodiment, a computer program product including one or more sequences of one or more instructions which, when executed by one or more processors, cause an apparatus to receive a request to execute an application at a device. The application includes a set of protocol features. The apparatus is also caused to determine one or more protocols for the application based, at least in part, on one or more criteria. The apparatus is further caused to determine a subset of the protocol features to enable or disable based, at least in part, on the one or more protocols.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of customizing application protocols, according to one embodiment;

FIG. 1B is a diagram of an example system capable of customizing application protocols, according to one embodiment;

FIG. 2 is a diagram of the components of user equipment capable of implementing customized application protocols, according to one embodiment;

FIG. 3 is a diagram of a set of protocol features from which applications protocols can be customized, according to one embodiment;

FIG. 4 is a flowchart of a process for customizing application protocols, according to one embodiment;

FIG. 5 is a flowchart of a process for configuring application protocols for customization, according to one embodiment;

FIG. 6 is a diagram of user interfaces utilized in the processes of FIGS. 4 and 5, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for applying policy rules to acquire resources are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

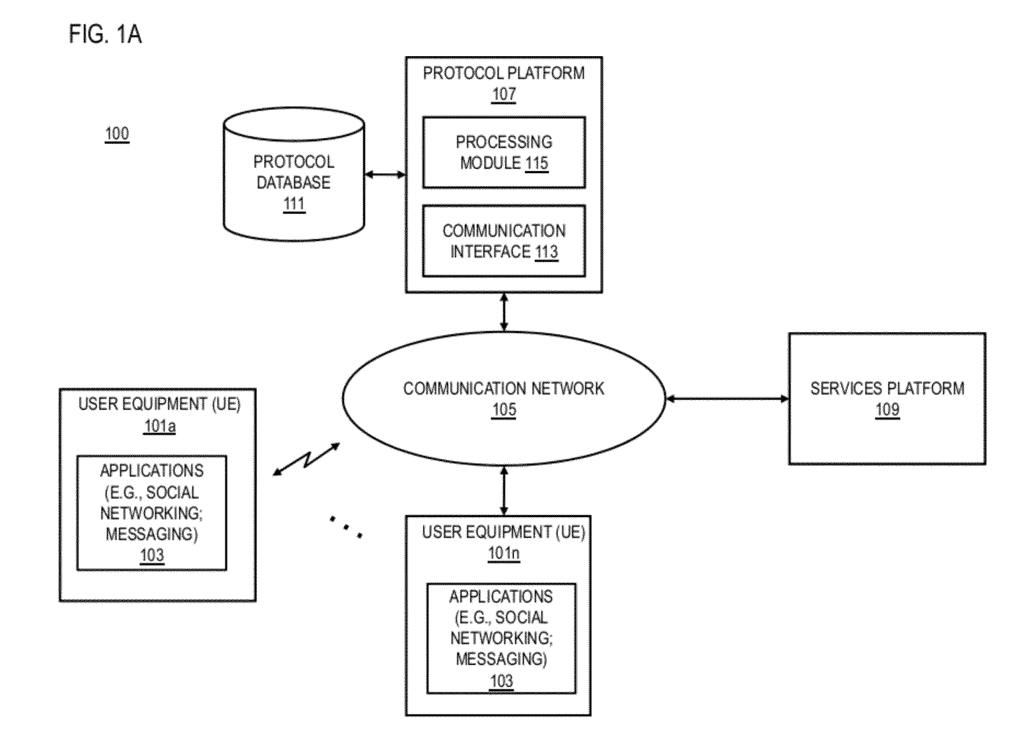

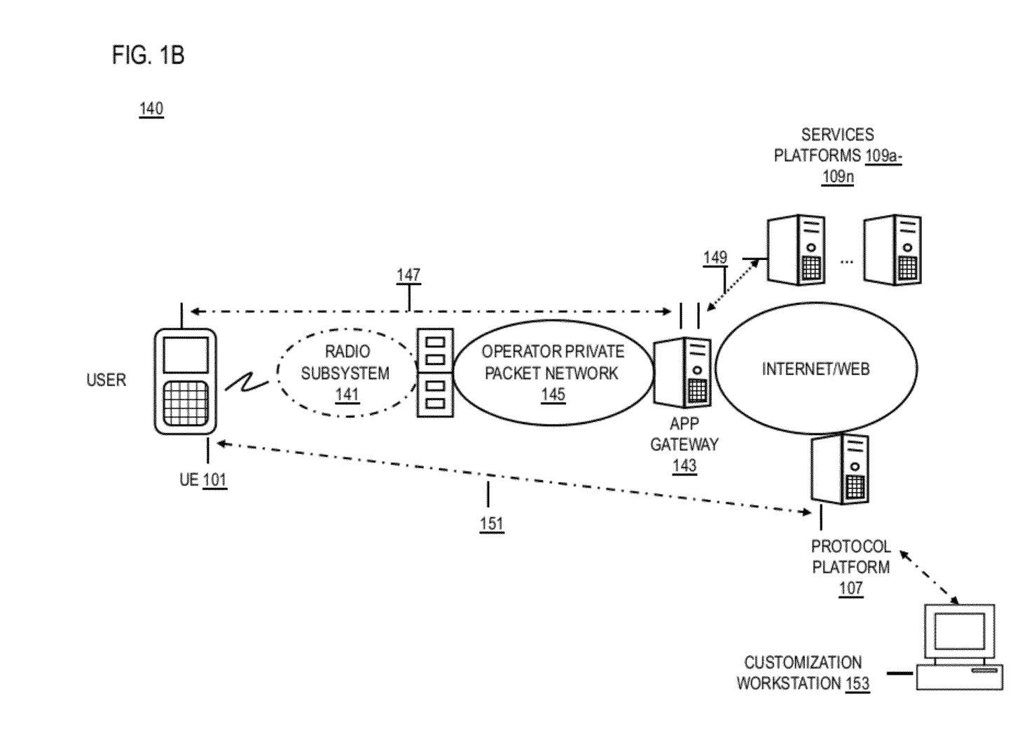

FIG. 1A is a diagram of a system capable of customizing application protocols, according to one embodiment. The approach described herein relates to application protocols (e.g., messaging protocols) that are, for instance, used between a software application executing at a client device and a corresponding server or gateway providing a service associated with the application. Application protocols may also be used to communicate or otherwise interact among peer devices without need for a server or gateway. As used herein, a protocol describes the format and rules for signaling instructions, messages, data, etc. among devices. In one sample use case, the software application may be a messaging application with connectivity to a server providing instant messaging services according to a predetermined messaging protocol. Although various embodiments are discussed with respect to messaging protocols, it is contemplated that the approach described herein is applicable to any application protocol including protocols for handling media, file transfer protocols, voice protocols, video protocols, and the like.

As discussed above, service providers (e.g., instant messaging providers) as well as network operators (e.g., cellular network operators) often specify or request customization of the protocols when used in particular applications. For example, a messaging application in a device can be deployed in several communication networks to provide access to different messaging service providers and communities such as Ovi, Yahoo, Microsoft Network (MSN), etc. via a gateway. Typically, a common protocol (e.g., a messaging protocol) is used between the application executing at the device and the gateway. The common protocol often may have different optional protocol constructs or features and different ways to realize the same service element. However, each network operator and service provider may require a different subset of this common protocol.

As a result, application developers and device manufacturers historically have had to modify the code for each messaging application to provide for the different customizations and requirements imposed by network operators and/or service providers. For mobile devices (e.g., cell phones, smartphones, etc.), software is often included as part of a firmware image. Accordingly, once this customization is complete and tested, the new software application is loaded in the device at the factory prior to shipping the device sales. Therefore, customization each device for each possible permutation of network operator and service provider can be burdensome and costly. Moreover, when updates occur to the protocols, these updates typically are conveyed as firmware updates that can also be costly to develop and deploy to devices already in use in the field.

To address these problems, a system 100 of FIG. 1A introduces the capability to dynamically customize application protocols at one or more user equipment (UEs) 101a-101n executing respective applications 103 that can be used across multiple networks, services, devices, etc. that are accessible over the communication network 105. More specifically, the system 100 deploys a common application 103 that includes a predetermined set of protocols features that can be enabled or disabled individually or in combination to implement one or more customized protocols. As used herein, a protocol feature corresponds to a function, sub-function, component, descriptor, etc. of an application protocol. In this way, an application developer and/or device manufacturer does not need to develop a different version of the client application 103 for each desired customization, thereby advantageously reducing the burden associated with maintaining and supporting multiple version of the same software application.

Instead, in one embodiment, the application 103 can interact with the protocol platform 107 to retrieve and/or otherwise determine the application protocols to implement according to one or more criteria (e.g., network in which the application is operating, the specific service provider, the type of device executing the client application, etc.). As shown, a protocol platform 107 coordinates the customization of applications protocols associated with the services platform 109. By way of example, the application 103 is a client of one or more services (e.g., communication services, messaging services, media services, etc.) of the services platform 109. For customization, the services providers associated with the services platform select a corresponding subset of the features (e.g., a subset of the optional features) provided for in the application 103. In one embodiment, the customization information may be provided to the protocol platform 107 as a customization file and stored in the protocol database 111. In certain embodiments, the application 103 downloads the customization file to configure the appropriate protocols. The customization file may be selected according to the criteria discussed above. By way of example, the customization file instructs the application which of the protocol features to enable or disable to implement the customized protocol.

Determining and/or downloading customization information from the protocol platform 107 provides a flexible solution because it removes the need and the cost to include customized protocols in the application 103. Accordingly, the same client application 103 may be distributed for use on any network or service. In one embodiment, the application 103 retrieves the customization information and/or file on initialization or a first execution of the application 103 at a device. In another embodiment, the application may periodically check for updates to the protocol and then retrieve any updated customization information if available. This updated customization information can then configure (e.g., enable/disable) the protocol features of the application 103 accordingly. In yet another embodiment, the application 103 and/or the UE 101 can detect when one or more selection criteria changes (e.g., network in which the application is operating, the specific service provider, the type of device executing the client application, etc.) and then retrieve a new customization file based on the changed criteria.

As discussed earlier, including customized protocols for one or more service providers and/or network operators in the manufacturing and/or packaging phase of creating a UE 101 for a consumer has overhead costs and/or technological costs. For example, an overhead cost may exist in creating multiple separate client applications for the UE 101 based on the individual service provider and/or network operator. An example of a technological cost would be that additional memory would be used in storing multiple customizations. This could be undesirable for UEs 101 with limited storage capabilities. Also, hard-coded protocols make it more difficult to quickly update the application to reflect new protocols or updates to existing protocols. Moreover, hard-coded protocols make it more difficult or inefficient (e.g., requires more storage space) to use the same client application 103 across networks, devices, services, etc.).

Because different operators or service providers may have different preferences and because of bandwidth concerns, and/or other reasons, determining when to enable or disable protocol features. For example, for certain network operators (e.g., in the case of cellular phone UEs); it may be important to limit optional protocol features that have significant resource requirements. As such, criteria such as one or more timing preferences for enabling and/or disabling certain protocol features can be included in the customization information or file. Thus, in certain embodiments, the customization files may include timings and/or states for enabling or disabling protocol features based on one or more parameters. The parameters may include the type of client application 103, a network operator associated with the UE 101, a service provider associated with the application 103, a connection status (e.g., connection costs, cellular network connection, wired or wireless broadband connection, etc.), a combination thereof, etc.

When the application 103 determines that customization information should be retrieved, the application 103 can be caused to generate and transmit a request to the protocol platform 107 for the customization information or file via the communication network 105. A communication interface 113 of the protocol platform 107 can receive the request. Then, a processing module 115 of the protocol platform 107 can parse the request and retrieve requested customization information from the protocol database 111. The communication interface 113 can then be utilized to transmit a response including the requested customization information. The application 103 can receive the customization information and proceed to implement the customized protocol by enabling or disabling the protocol features as specified in the customization information or file.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, application 103, protocol platform 107, and services platform 109, communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the protocol platform 107 and/or services platform 109 may interact according to a client-server model with the applications 103 of the UE 101. According to the client-server model, a client process sends a message including a request to a server process, and the server process responds by providing a service (e.g., messaging, e-mail, gaming, social networking, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

FIG. 1B is a diagram of an example system 140 capable of customizing application protocols, according to one embodiment. In this embodiment, the UE 101 can act in a mobile environment connected to a communication network via an operator radio subsystem 141. The radio subsystem 141 can be utilized to communicate with an application gateway 143 via a packet network 145 (e.g., an operator private packet network). As such, the operator can create an interface 147 (e.g., an application programming interface (API), messaging interface, etc.) between the application gateway 143 and the UE 101. The application gateway 143 can then communicate with one or more services platforms 109a-109n. In certain embodiments, an application 103 of the UE 101 can connect to a particular services platform 109 based on a user preference, availability, etc. The application gateway 143 can utilize another interface 149 to connect to the services platforms 109. Communication between the application gateway 143 and services platforms 109 may use a protocol specific to the service provider associated with the services platform 109. In certain embodiments, a role of the application gateway 143 is to perform mappings between one or more protocols used to communicate with the UE 101 and protocols used to communicate with the services platforms 109.

In certain embodiments, an interface 151 between the UE 101 and the protocol platform 107 can be implemented using the application gateway 143, the packet network 145, the radio subsystem 141, as well as other communication networks. The UE 101, when manufactured, or at some other point can include an address (e.g., a URL) to the protocol platform 107 to access information stored on the protocol platform 107.

In some embodiments, the first time the UE 101 is utilized or activated, the first time a particular application 103 is utilized, etc., the UE 101 contacts the protocol platform 107 to download retrieve information or a file for customizing one or more protocols of the application 103. By way of example, the application 103 (e.g., an instant messaging client) can customize an application protocol (e.g., an instant messaging protocol such as the Open Mobile Alliance's Instant Messaging and Presence Service V1.3 protocol) for use in communication with the gateway 143. The application gateway 143, in turn, communicates with one or more servers (e.g., instant messaging servers) of the services platforms 109a-109n based on the service provider selected at the application 103. For example, the communication between the gateway 143 and the servers of the services platform 109a-109n use protocols specific or customized to the corresponding or selected service provider. The main role of the gateway 143 is to perform, for instance, the mappings between the protocol used with the application 103 and protocol used with the service providers.

In the approach described herein, the application 103 has access to the address (e.g., a Uniform Resource Locator (URL)) of the server of the selected service provider. The first time the user executes the application 103, the application 103 contacts the protocol platform 107 to download a protocol configuration file as described above. The configuration file contains several items including the selected subset of the protocol features (e.g., Client Server Protocol (CSP)) to be used for a particular network or service. After downloading the configuration file, the application 103 will know which protocol features are allowed in the network or service.

As shown, the customization workstation 153 has connectivity to the protocol platform 107 to enable a customization specialist to send to the protocol platform 107 the selected subset of the protocol features to use in a particular network or service. It is contemplated that the subset is sent on first configuration of the service and on any subsequent updates to the allowed features of the service or protocol. For example, a stakeholder may include a network operator (e.g., Verizon™, Sprint™, etc.) or application service provider (e.g., an instant messaging service provider such as Yahoo! Messenger™, Nokia Ovi Messaging™, etc.).

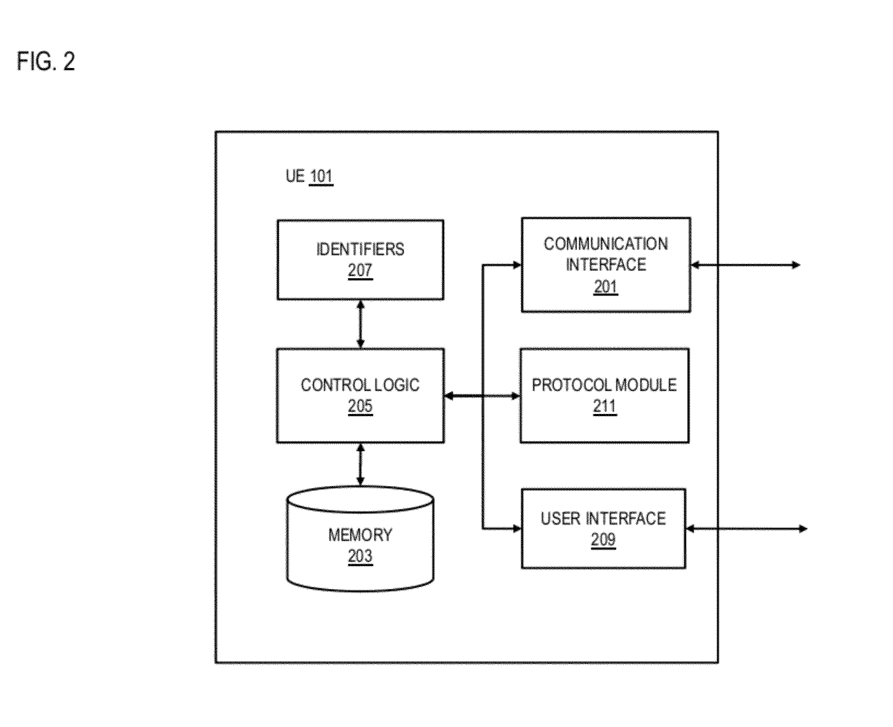

FIG. 2 is a diagram of the components of user equipment capable of customizing application protocols, according to one embodiment. By way of example, the UE 101 includes one or more components for implementing the policy rules to manage and/or customize application protocols used by a client application. It is contemplated that the functions of these components may be combined in one or more components or performed by other components of equivalent functionality. In this embodiment, the UE 101 includes a communication interface 201, a memory 203, control logic 205, one or more identifiers 207, a user interface 209, and a protocol module 211.

In one embodiment, the communication interface 201 can be used to communicate with the protocol platform 107 and services platforms 109. Certain communications can be via methods such as an internet protocol, messaging (e.g., Short Message Service (SMS), Multimedia Messaging Service (MMS), etc.), or any other communication method (e.g., via the communication network 105). In some examples, the UE 101 can send requests and receive protocol customization or configuration information from the protocol platform 107. Additionally, the UE 101 can receive and/or access services from the services platform 109. Further, the communication interface 201 can be utilized to communicate with other UEs 101.

Further, the control logic 205 can utilize the communication interface 201 to download protocol customization information to store in memory 203. Moreover, the communication interface 201 can be utilized to request and receive corresponding configuration files. The files can also be stored in the memory 203.

The user interface 209 can include various methods of communication. For example, the user interface 209 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc. In certain embodiments, the user interface 209 and/or control logic 205 can be means for presenting graphical resources to users as well as communicating services to users.

In one scenario, one or more identifiers 207 are utilized by the policy module 211 to determine what application protocols to acquire via the communication interface 201. For example, the identifiers 207 may include a client identifier that identifies a client and/or provides information about the UE 101 (e.g., device type, version of the hardware and/or software on the UE 101, etc.). Different client types may be associated with different application protocols. Moreover, the identifiers 207 may include a mobile network identifier identifying an operator of a communication network 105 that the UE 101 is part of. Moreover, other identifiers 207 (e.g., an identifier of a selected service and/or service provider) can be on the UE 101. In one embodiment, one or more of the identifiers 207 are detected via a hardware chip (e.g., a Subscriber Identity Module (SIM)) or stored in memory 203.

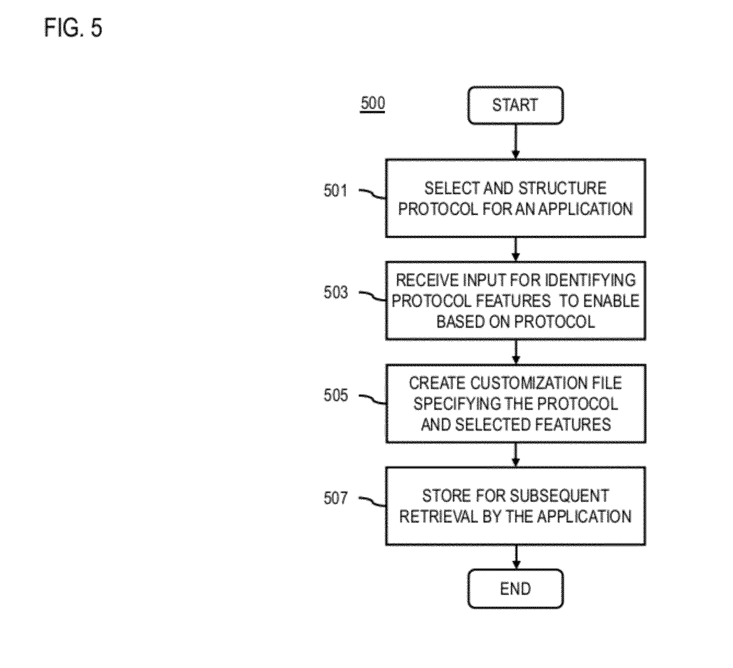

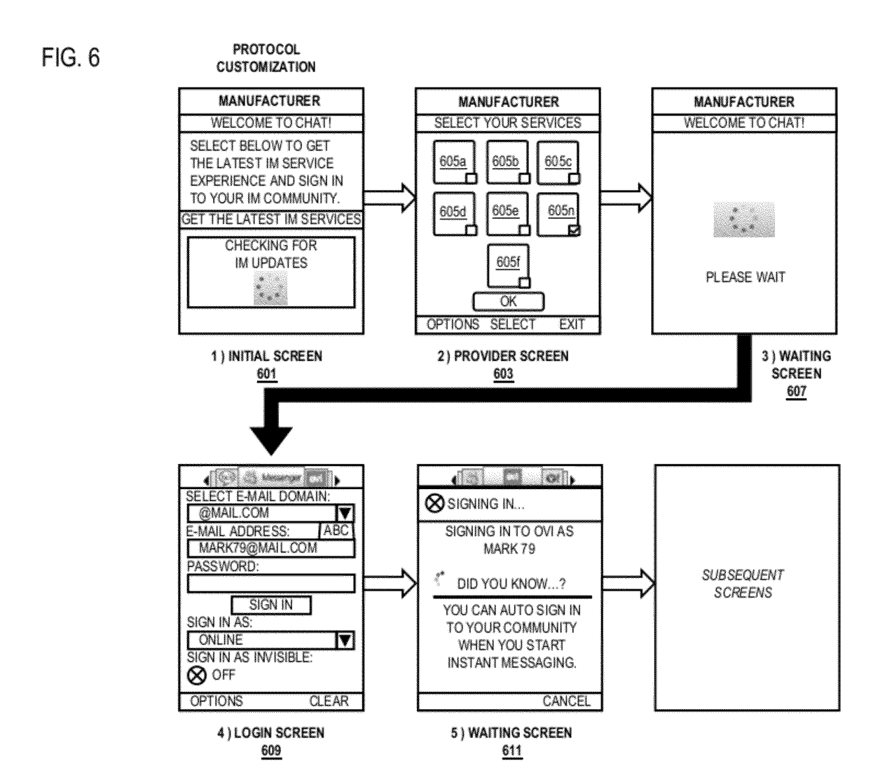

The policy module 211 can parse configuration information and/or application protocols in the memory 203 to determine how to conduct communications via the communication interface 201. Further, in certain instances, during execution of an application 103, the user interface 209 can display one or more services to the user retrieved according to the application protocols. During the execution of the application 103, the user interface 209 can be caused to present the information and content of the application 103 as further detailed in FIGS. 5 and 6.

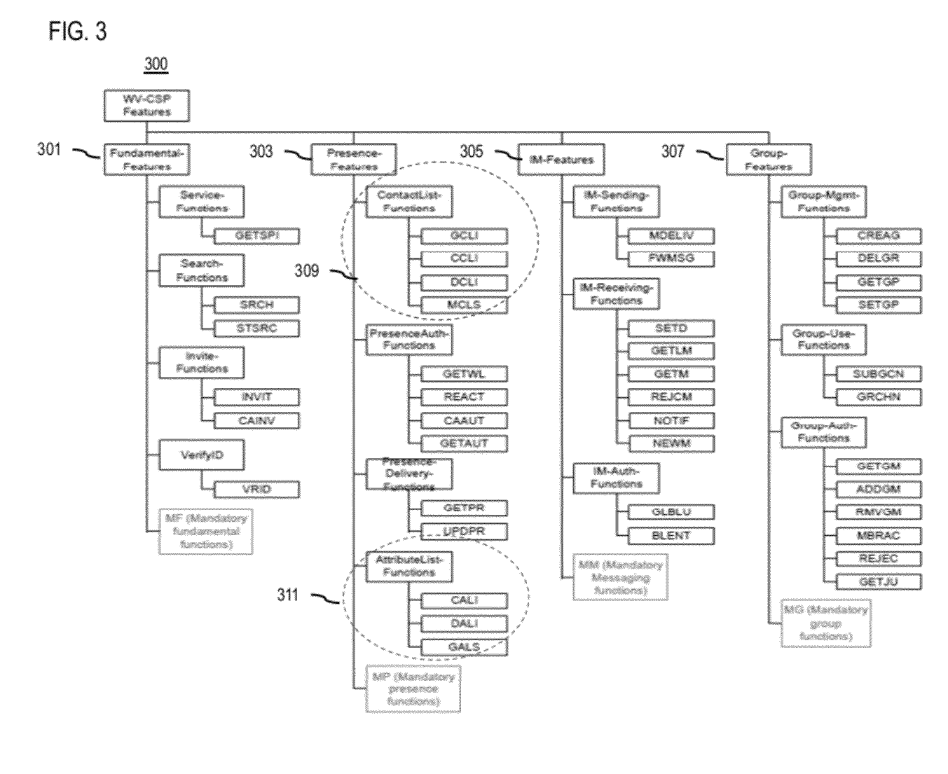

FIG. 3 is a diagram of a set of protocol features from which applications protocols can be customized, according to one embodiment. The protocol structure 300 is an example of a Wireless Village Client Server Protocol (WV-CSP, as defined in “Open Mobile Alliance, Client-Server Protocol Session and Transactions,” Approved Version 1.3, Jan. 23, 2007, page 55, FIG. 13, incorporated by reference herein in its entirety). In this case, the protocol structure 300 is organized as a number of hierarchical service components such as Fundamental Features 301, Presence Features 303, Instant Messaging (IM) Features 305, and Group Features 307. Each of the service components is further subdivided into a number of subcomponents. For example, the Presence Features 303 includes a ContactList Functions subcomponent 309 and an AttributeList Functions subcomponent 311, among others.

The subcomponents can be further divided into protocol features. For example, the ContactList Functions subcomponent 309 is a set of features about the list of contacts (e.g., friends) in an instant messaging service. This set includes the following protocol features: get contact list (GCLI) feature, create contact list (CCLI) feature, delete contact list (DCLI) feature, and management of contact list contents (MCLS) feature. The CGLI protocol feature enables the application 103 to retrieve the name of each contact list in a user's account. The CCLI protocol feature enables the application 103 to create a contact list. The DCLI protocol feature enables the application 103 to delete a contact list, and the MCLS protocol feature enables the application 103 to manage a contact list (e.g., delete, change, or add contacts in a contact list).

In one embodiment, the application 103 is coded to include the possibility to enable all or substantially all of the features enumerated in the protocol structure 300. Then, each network operator and/or service provider that wishes to customize the protocol can either select to allow or disallow any of the features. For example, one operator may allow the application 103 to manage a contact list (e.g., enable MCLS) but disallow the application 103 to delete a contact list (e.g., disable DCLI). Another operator or service provider may make different selections for customization. In traditional approaches, the application developer and/or device manufacturer would have to create a separate version with the features enabled or disabled according to the operator and/or service provider customizations. However, in the approach described herein, the developer or manufacturer can create one version of the application 103 and then specify configuration or customization information to enable or disable the individual protocol features to implement the desired customizations.

In some embodiments, the protocol structure 300 can be used as a feature selection template. For example, the hierarchical structure 300 can be presented to a customization specialist for selection. The selection of a node of the hierarchy can automatically select the nodes below it for more rapid selection. For example if the ContactList Functions subcomponent 309 is selected, all of the nodes corresponding to its features can also be selected. However, if the node GCLI is selected, only this node is selected because it is a bottom (or leaf) node.

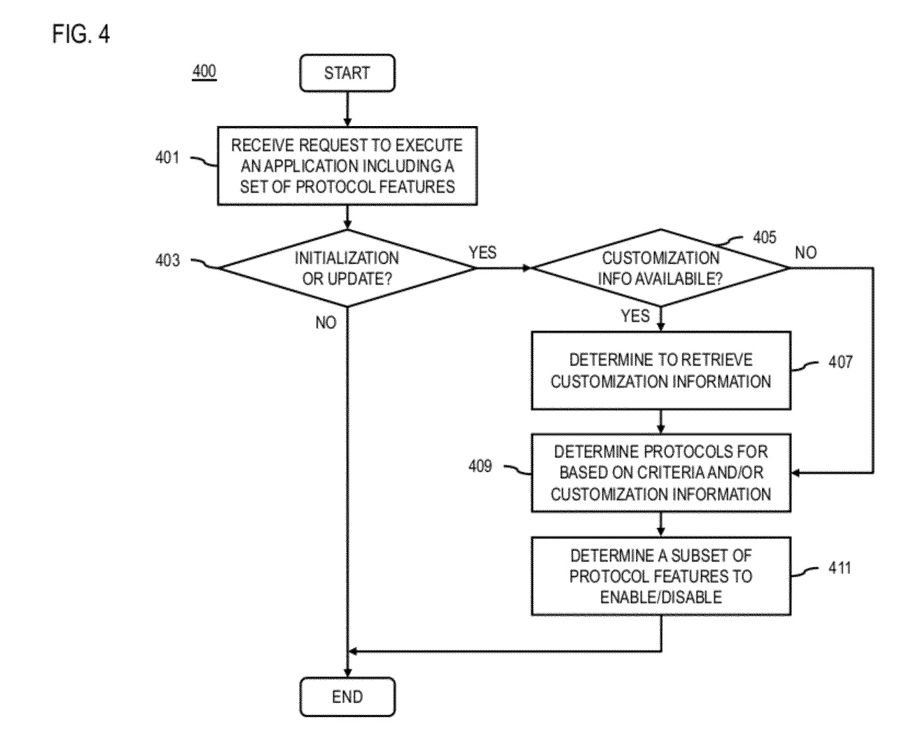

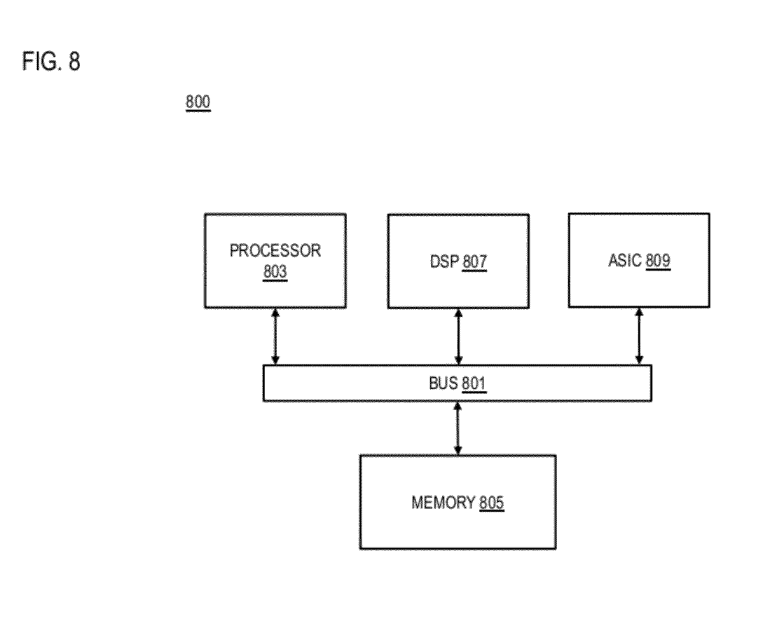

FIG. 4 is a flowchart of a process for customizing application protocols, according to one embodiment. In one embodiment, the application 103 performs the process 400 and is implemented in, for instance, a chip set including a processor and a memory as shown in FIG. 8. In addition or alternatively, the protocol platform 107 and/or the services platform 109 can perform all or a portion of the steps of the process 400. As such, the application 103, the protocol platform 107, and/or the services platform 109 can provide means for accomplishing various parts of the process 400 as well as means for accomplishing other processes in conjunction with other components of the UE 101.

In step 401, the application 103 receives or otherwise acts on a request to execute the application at the UE 101. In the case where the application 103 is performing the process 400 the application 103 is launched or executed upon this request by, for instance, an operating system of the UE 101. If the protocol platform 107, the services platform 109, or other similar component is performing the process 400, the request initiates the execution of the application 103. In one embodiment, on launch, the application 103 can optionally determine whether this is the first execution or an initialization/re-initialization of the application 103 (step 403). On first execution or initialization, the application 103 typically does not have information on potential customizations of applicable application protocols. However, because the application 103 has been coded to include all or substantially all of a full set of protocol features that are anticipated to be used at the UE 101, the application 103 retains to the potential to implement the any customizations based on a subset of the features.

In this state, the application 103 can either operate with all protocol features enabled, all protocol features disabled, or not permit use until applicable application protocols are determined. The default behavior can be configured by the device manufacturer, network operator, service provider, and/or the like. In step 405, the application 103 can determine whether customization information (e.g., a customization or configuration file) is available from, for instance, the protocol platform 107. If the customization information is available, the application 103 determines to retrieve the customization information (step 405). This retrieval is based on one or more predetermined criteria including a service provider associated with the application, an operator of a network associated with the device, a capability of the device, context information associated with the device, or a combination thereof. For example, if the UE 101 is operating within Network A, the UE 101 may request customization files associated with Network A. The criteria may also be used in combination; for example, the device capability in connection with the network operator may cause the application 103 to request different configuration files.

In addition, the application 103 may determine context information associated with the UE 101 (e.g., location, available bandwidth, resource load, time, date, activity, etc.) to apply different potential protocol customizations. For example, if context information indicates that the UE 101 in a public location, the application 103 may use a customized application protocol that does not allow management of contact lists (e.g., in case the device is picked up and used by someone other than the user). If the context or other factors for evaluating the criteria change, then the application 103 can request new customization information. In some embodiments, the customization information can be cached at the UE 101 so that when the context changes, the application 103 can retrieve the appropriate customization information.

Once the customization information is obtained, the application 103 can determine the customized protocols based on the information (step 409). In some cases, the protocols can also be based on the criteria as discussed with respect to step 407 above. Based, on the determined protocols, the application 103 can determines a subset of the protocol features corresponding to the protocols (step 411). The application 103 enables the subset of the protocol features that are specified and disables all other features. In the case of multiple services and multiple corresponding customizations, the application 103 can enable/disable the set of protocol features on a service by service basis.

In one embodiment, the application 103 can also customize its user interface to show only those features that are available based on the customized application protocol. For example, if creating a contact list is not allowed by the application protocol, then the application 103 does not display the option to create a contact list as an available command.

FIG. 5 is a flowchart of a process for configuring application protocols for customization, according to one embodiment. In one embodiment, the protocol platform 107 performs the process 500 and is implemented in, for instance, a chip set including a processor and a memory as shown in FIG. 8. In this embodiment, an instant messaging application 103 is utilized as an example to explain the process 500. At step 501, the protocol platform 107 identifies a protocol (e.g., a messaging protocol) applicable to an application 103. Based, on the protocol, the protocol platform 107 creates a structure (e.g., the protocol structure 300 of FIG. 3) sot that a configuration specialist can determine which features to include in the configuration file and which features are not allowed or otherwise not required. In one embodiment, the step is performed only once when the protocol is defined or before any customization is performed.

In step 503, the protocol platform 107 receives an input from, for instance, the configuration specialist for identifying protocol features to enable or disable based, at least in part, on the selected protocol or other requirements specified by the network operator and/or service provider. As discussed above with respect to FIG. 3, the input can be made by selecting nodes that represent components, subcomponents, and/or features of the protocol in a hierarchical tree format. In addition, with respect to the ContactList Functions subcomponent 309 of the CSP protocol, the specialist can select from, for instance, four protocol features: GCLI (get contact list), CCLI (create contact list), DCLI (delete contact list), and MCLS (manage contact list). A customization input may, for example, allow GCLI and MCLS only, while disallowing a user from creating or deleting the user's own contact lists(s). Hence by knowing the network operator and/or service provider requirements and by knowing the protocol structure, the configuration specialist is able to build the configuration or customization file with the protocol features to implement a customized application protocol.

In step 505, in one embodiment, the protocol platform 107 creates the configuration file in an appropriate software-oriented language. A fragment of an example configuration file is shown below in Table 1.

TABLE 1

```
<Service-Request>
  ...
<PresenceFeat>
  ...
<ContListFunc>
  <GCLI/>
  <MCLS/>
</ContListFunc>
```

The configuration specification of Table 1 uses eXtensible Markup Language (XML) to describe the required protocol features. The fragment starts with the element <Service-Request> as the top XML element. <Service-Request> identifies hierarchically all the requested protocol features. The “ . . . ” means that some features are skipped from the example. <PresenceFeat> contains all the requested presence-related features. Although the example lists only <ContListFunc> of the presence features with entries corresponding to enabling the GCLI and MCLS features of the ContactList Functions subcomponent 309, it is contemplated that the configuration specialist will add the appropriate feature information in the configuration file for every protocol feature that is to be enabled in the customized application protocol. The configuration file is then stored at the protocol platform 107 for subsequent retrieval by the application 103.

As discussed with respect to the process 400 of FIG. 4, a main step of the protocol customization process is for the client application 103 to download the configuration file when the application 103 runs for the first time or is otherwise initialized. Based on the configuration file, the application 103 determines the customized protocol and enables/disables the appropriate protocol features accordingly. In one embodiment, the application 103 displays only the features specified or customized for the current environment. For example, since the contact list function DCLI was not enabled or allowed, the application 103 will not display to the user the option to delete a contact list.

In another embodiment, the application 103 can also return a status code (e.g., a CSP status primitive) to the services platform 109 when the application 103 receives a request from the services platform 109 about a function the application 103 does not support. By way of example, the status tells the services platform 109 that the requested function is not available or supported by the application 103.

In yet another embodiment, the application 103 uses the customized protocol to negotiate with the services platform 109 the requested service features to be used for each session. For example, with CSP, once the user/application 103 is signed into the services platform 109, the next step is for the application 103 to negotiate the desired features for the session. In one embodiment, the features are maintained until the user logs out.

FIG. 6A is a diagram of user interfaces utilized in the processes of FIGS. 4 and 5, according to various embodiments. In one embodiment, during an initialization screen 601 of a chatting service application, the UE 101 is caused, at least in part, to download a configuration file (e.g., a configuration file including one or more customized application protocols and/or protocol features) from the protocol platform 107. The initialization screen 601 may occur during the first run of the client application or a subsequent initialization process. In certain embodiments, the download and customization of protocol features may occur during or before an available chat services provider screen 603 is presented or in the background while other processes occur. The user is able to select one or more chat service providers 605a-605n to utilize. Customized protocols for the one or more service providers 605a-605n may be added as part of the initialization update according to the retrieved configuration file.

In addition, during the configuration phase, the UE 101, as determined by one or more policies, can download the protocol configuration files representing each of the service providers 605a-605n displayed in the screen 601. In this way, the customized protocols that are specific to the providers 605a-605n need not be hard coded or otherwise pre-included with the application 103, thereby avoiding the need for multiple customized versions of the same application across devices, networks, cell systems, etc. Moreover, if a provider decides to change its application protocol, the change may be made once on the network for propagation to the corresponding UEs 101.

When a service provider 605n is selected, the chatting service application can execute services (e.g., logging in, initializing graphics, etc.) associated with the service provider 605n. In certain embodiments, the start-up process includes presenting a waiting screen 607 should be presented while protocol customization information associated with the service provider 605n are downloaded, configured, and/or implement. Once customization information is downloaded and the corresponding protocol features are at least partially configured, the user can be requested to sign into the service at a login screen 609. Additionally, additional features specified by the customization information may continue to be implemented (e.g., enabled/disabled) at this step. In this manner, the UE 101 is able to download and/or implement subsets of the protocol customizations at one or more steps (e.g., each step) of the user interface flow (e.g., from an initial splash screen to a buddy list execution for a chat application). The sequence of implementing the protocol features can be dependent on the specific states of the user interface interaction and when the features are used or accessed.

Moreover, the customization information can be utilized to block or disable certain features or the protocol and application 103. For example, the user may be presented with a feature option only if the application protocol supports the feature. As previously described, if the delete contact list feature is disabled in the protocol, the application 103 will not display delete as a possible option. As the user progresses through the user interface flow, the user can be displayed additional wait screens (e.g., wait screen 611) during which additional features of the application protocol can be enabled/disable according to the customization information. Once customized protocol is fully implemented, the user can operate the application freely. It is contemplated that the application 103 can check for and update the protocols periodically or according to predetermined schedule or criteria (e.g., available bandwidth, or periods in which free network access is available).

With the above approaches, a manufacturer of a UE 101 and/or application is able to more efficiently and more effectively package a product (e.g., an application). Further, the manufacturer can reduce the amount of different products and/or application versions. In this manner, the manufacturer need not generate separate products and/or application versions for various service providers and/or network operators. Instead, the same version can be dynamically customized to implement any application protocol that uses a subset of the protocol features included in the application code.

The processes described herein for customizing application protocols may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

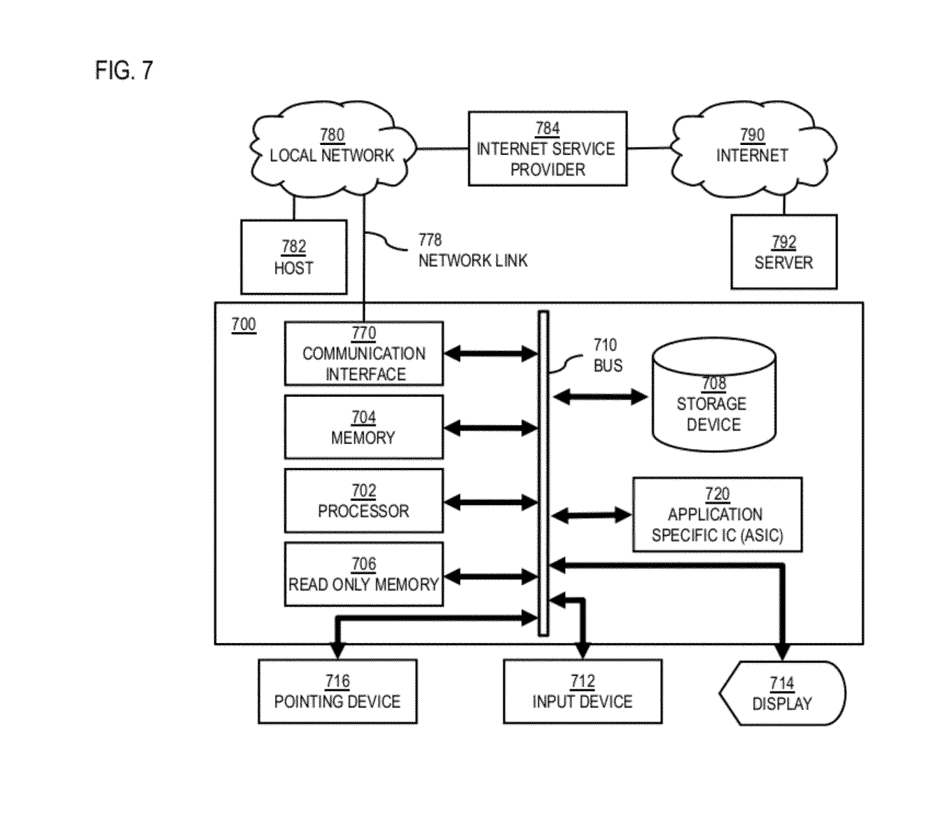

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to customize application protocols as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of customizing application protocols.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to customizing application protocols. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for customizing application protocols. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for customizing application protocols, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for customizing application protocols.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to customize application protocols as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of customizing application protocols.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to customize application protocols. The memory 805 also stores the data associated with or generated by the execution of the inventive steps.

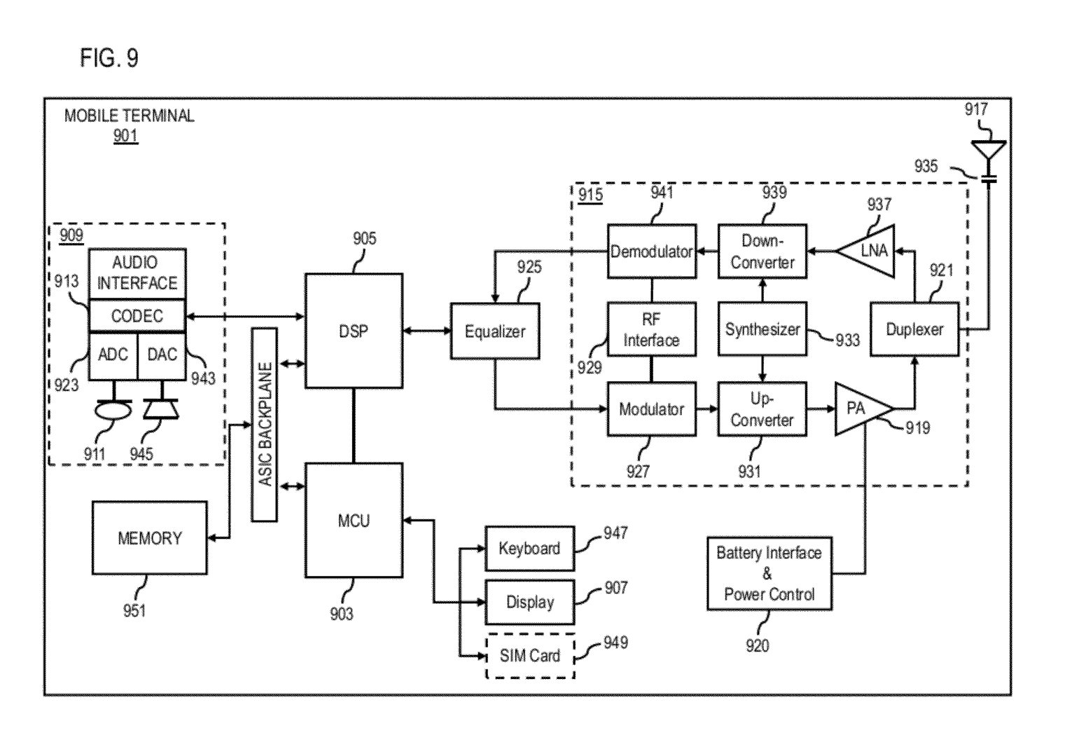

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of customizing application protocols. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of customizing application protocols. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to customize application protocols. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving a request to execute an application at a device, wherein the application includes a set of protocol features;
determining one or more protocols for the application based, at least in part, on one or more criteria; and
determining a subset of the protocol features to enable or disable based, at least in part, on the one or more protocols.

2. A method of claim 1, further comprising:
determining to retrieve customization information in response to the request,
wherein the determining of the one or more protocols is further based, at least in part, on the customization information.

3. A method of claim 1, further comprising:
determining whether there are one or more updates to the one or more protocols at a predetermined frequency, a predetermined schedule, or a combination thereof; and
determining to update the subset based, at least in part, on the one or more updates to the one or more protocols.

4. A method of claim 1, further comprising:
determining one or more changes related to the one or more criteria, and
determining to update the subset based, at least in part, on the one or more changes.

5. A method of claim 1, wherein the one or more criteria include a service provider associated with the application, an operator of a network associated with the device, a capability of the device, context information associated with the device, or a combination thereof.

6. A method of claim 1, further comprising:
determining to present one or more functions of the application corresponding to the subset.

7. A method of claim 1, wherein the application is associated with one or more service providers, and wherein the one or more service providers specify the one or more protocols.

8. A method of claim 1, wherein the protocol is a messaging protocol.

9. An apparatus comprising:
at least one processor; and
at least one memory including computer program code for one or more programs,
the at least one memory and the computer program code configured to, with the at least one processor, cause the apparatus to perform at least the following,
receive a request to execute an application at a device, wherein the application includes a set of protocol features;
determine one or more protocols for the application based, at least in part, on one or more criteria; and
determine a subset of the protocol features to enable or disable based, at least in part, on the one or more protocols.

10. An apparatus of claim 9, wherein the apparatus is further caused to:
determining to retrieve customization information in response to the request,
wherein the determining of the one or more protocols is further based, at least in part, on the customization information.

11. An apparatus of claim 9, wherein the apparatus is further caused to:
determining whether there are one or more updates to the one or more protocols at a predetermined frequency, a predetermined schedule, or a combination thereof; and
determining to update the subset based, at least in part, on the one or more updates to the one or more protocols.

12. An apparatus of claim 9, wherein the apparatus is further caused to:
determining one or more changes related to the one or more criteria, and
determining to update the subset based, at least in part, on the one or more changes.

13. An apparatus of claim 9, wherein the one or more criteria include a service provider associated with the application, an operator of a network associated with the device, a capability of the device, context information associated with the device, or a combination thereof.

14. An apparatus of claim 9, wherein the apparatus is further caused to:
determining to present one or more functions of the application corresponding to the subset.

15. An apparatus of claim 9, wherein the application is associated with one or more service providers, and wherein the one or more service providers specify the one or more protocols.

16. An apparatus of claim 9, wherein the protocol is a messaging protocol.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
receiving a request to execute an application at a device, wherein the application includes a set of protocol features;
determining one or more protocols for the application based, at least in part, on one or more criteria; and
determining a subset of the protocol features to enable or disable based, at least in part, on the one or more protocols.

19. A computer-readable storage medium of claim 18, wherein the apparatus is caused to further perform:
determining to retrieve customization information in response to the request,
wherein the determining of the one or more protocols is further based, at least in part, on the customization information.

20. A computer-readable storage medium of claim 18, wherein the apparatus is caused to further perform:
determining whether there are one or more updates to the one or more protocols at a predetermined frequency, a predetermined schedule, or a combination thereof; and
determining to update the subset based, at least in part, on the one or more updates to the one or more protocols.

21.-42. (canceled)
